(19) United States
(12) Patent Application Publication
(10) Pub. No.: US 2019/0145411 A1
(43) Pub. Date: May 16, 2019

(54) GAS EJECTION APPARATUS

(71) Applicant: DENSO TEN Limited, Kobe-shi (JP)

(72) Inventors: Masashi OTOMI, Kobe-shi (JP); Yasutaka YAMANAKA, Kobe-shi (JP)

(73) Assignee: DENSO TEN Limited, Kobe-shi (JP)

(21) Appl. No.: 16/151,771

(22) Filed: Oct. 4, 2018

(30) Foreign Application Priority Data
Nov. 14, 2017 (JP) 2017-219479

(51) Int. Cl. F04C 21/00; B60S 1/54

(52) U.S. Cl. CPC F04C 21/002; B60S 1/54

(57) ABSTRACT

A gas ejection apparatus includes a cylindrical cylinder, cylinder walls, blades, and a gas sending outlet. The cylinder walls divide an inside of the cylinder into a plurality of chambers. The blades send out gas in the plurality of chambers to an outside of the cylinder by a rotary motion of the blades that compresses the gas. The gas sending outlet is provided to each of the plurality of chambers on an end wall of the cylinder adjacent to a circumference of the cylinder.

### BACKGROUND OF THE INVENTION

### Field of the Invention

The invention relates to a gas ejection apparatus and a gas ejection system.

### Description of the Background Art

Conventionally, there has been a gas ejection apparatus that compresses intake gas and then ejects the compressed gas. One example of those gas ejection apparatuses is an apparatus that is installed on a vehicle to remove rain drops, snowflakes, dirt, dust, mud, etc. on a lens of an on-vehicle camera by ejecting compressed gas toward the lens.

However, the conventional gas ejection apparatus can be improved in terms of efficient ejection of the compressed gas from a cylinder that compresses the gas.

### SUMMARY OF THE INVENTION

According to one aspect of the invention, a gas ejection apparatus includes: a cylindrical cylinder, cylinder walls that divide an inside of the cylinder into a plurality of chambers; blades that send out gas in the plurality of chambers to an outside of the cylinder by a rotary motion of the blades that compresses the gas; and a gas sending outlet that is provided to each of the plurality of chambers on an end wall of the cylinder adjacent to a circumference of the cylinder.

Thus, it is possible to efficiently send out the compressed gas from the cylinder.

According to another aspect of the invention, the gas sending outlet includes a sloped wall that slopes upward from the inside of the cylinder toward the outside of the cylinder, the sloped wall sloping at a positive angle with respect to an axial direction of the cylinder.

Thus, it is possible to prevent a flow speed of the compressed gas to be sent out from decreasing.

Therefore, an object of the invention is to provide a gas ejection apparatus and a gas ejection system that more efficiently send out compressed gas from a cylinder.

These and other objects, features, aspects and advantages of the invention will become more apparent from the following detailed description of the invention when taken in conjunction with the accompanying drawings.

### BRIEF DESCRIPTION OF THE DRAWINGS

FIG. 1A is a perspective view illustrating a gas ejection system of this embodiment;

FIG. 1B is a perspective view illustrating a gas compressor;

FIG. 1C illustrates a motion of the gas compressor;

FIG. 2A is a perspective view illustrating an internal configuration of a gas ejection apparatus;

FIG. 2B is a schematic diagram illustrating a configuration of a driven gear and a preceding gear viewed from above;

FIG. 3 illustrates a more detailed motion of the gas compressor;

FIG. 4 is a top view illustrating an end face on a side on which flow paths of a cylinder of this embodiment are provided; and

FIG. 5 is a cross-sectional view of illustrating the cylinder of this embodiment along a line A-A′ shown in FIG. 4.

### DESCRIPTION OF THE EMBODIMENTS

A gas ejection apparatus and a gas ejection system of this embodiment will be described in detail below, with reference to the drawings. This invention is not limited to the embodiment described below.

Moreover, the gas ejection system in this embodiment will be described below, as an example, that is installed on a vehicle and ejects compressed gas to remove a rain drop, a snowflake, dust, dirt, mud, etc. attached on a lens of an on-vehicle camera that captures images of surroundings of the vehicle.

However, the gas ejection system of this embodiment is not only for being installed on a vehicle. In a case where the gas ejection system of this embodiment is installed on a vehicle, a target to which the compressed gas is ejected is not limited to the on-vehicle camera. The compressed gas may be ejected toward a front windshield glass, a rear windshield glass, a headlight, a side mirror, etc. Moreover, the compressed gas may be ejected toward an optical sensor, such as a radar apparatus that detects an object in the surroundings of the vehicle.

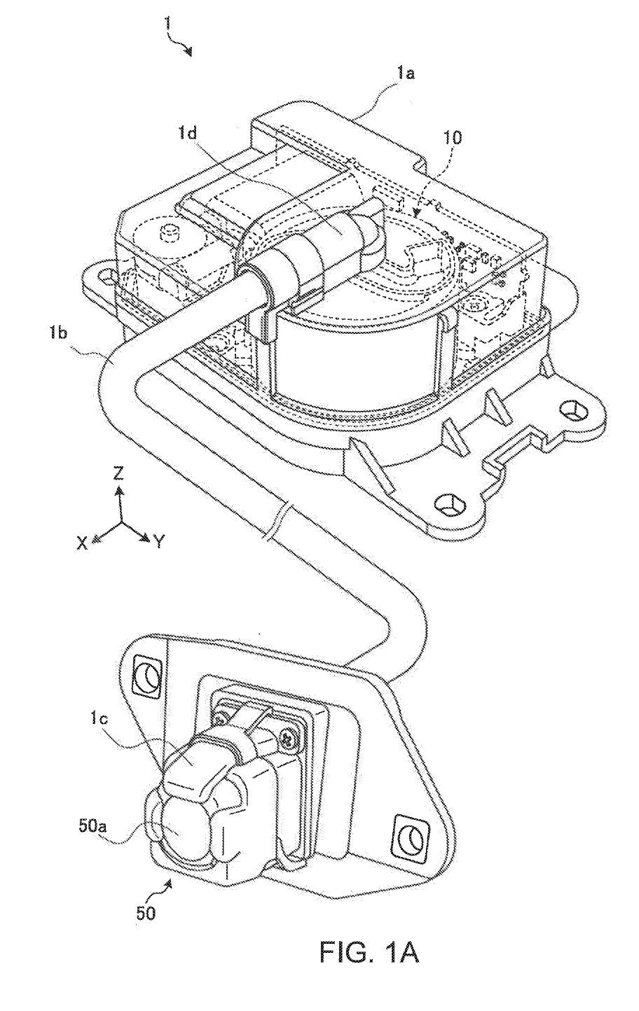

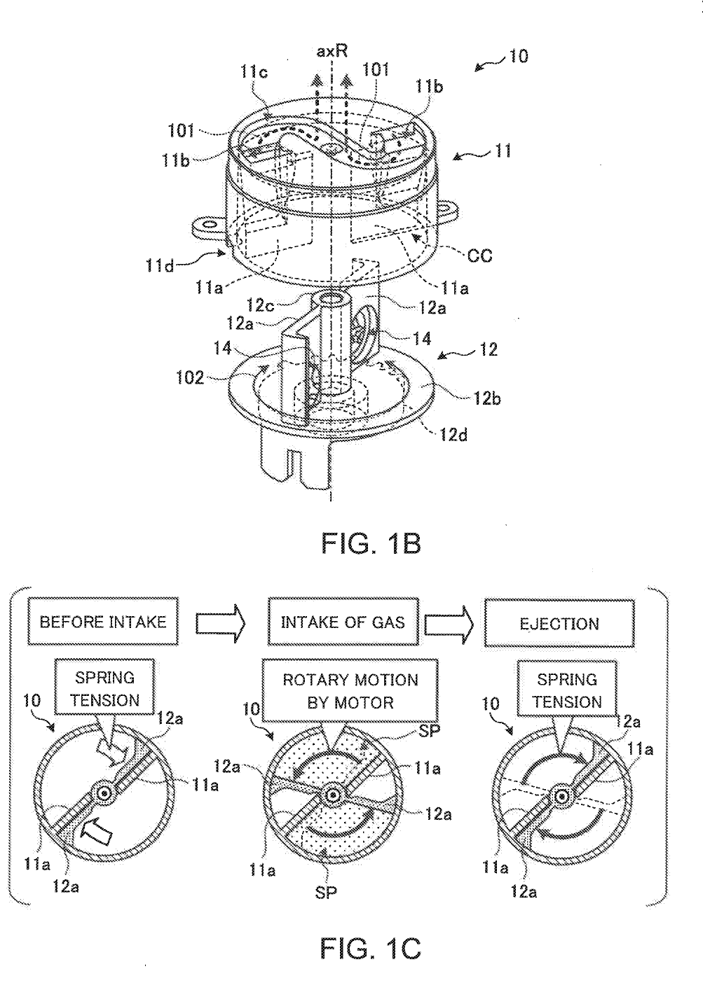

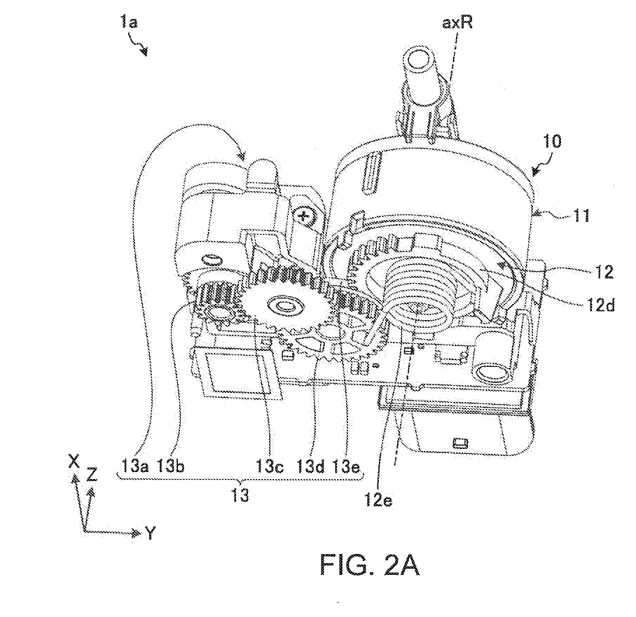

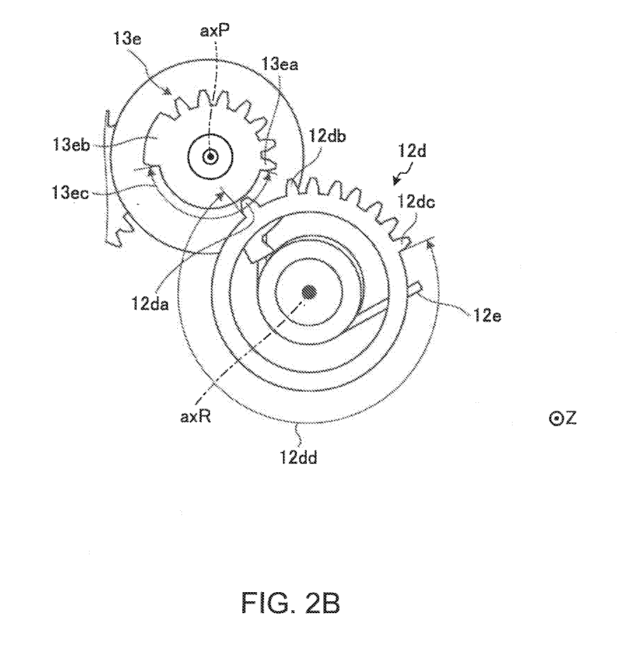

Moreover, a configuration outline of a gas ejection system 1 of this embodiment will be described below with reference to FIGS. 1A to 1C. Then, more specific configuration of the gas ejection system 1 of this embodiment will be described with reference to FIG. 2A and subsequent figures.

FIG. 1A is a perspective view illustrating the gas ejection system 1 of this embodiment. FIG. 1B is a perspective view illustrating a configuration of a gas compressor 10, and FIG. 1C illustrates a motion of the gas compressor 10.

As shown in FIG. 1A, the gas ejection system 1 includes a gas ejection apparatus 1a, a hose 1b, an ejection nozzle 1c, and a camera 50. The gas ejection apparatus 1a includes the gas compressor 10, and sends out the gas compressed by the gas compressor 10. FIG. 1A includes a Cartesian coordinate including an X-axis, a Y-axis, and a Z-axis that are orthogonal to one another. The Cartesian coordinate will be shown in another figure for explanation below.

One end of the hose 1b is connected to a forwarder 1d for the compressed gas of the gas ejection apparatus 1a, and the other end of the hose 1b is connected to the ejection nozzle 1c. The ejection nozzle 1c is installed on the camera 50 such that a gas jet orifice of the ejection nozzle 1c is directed toward a lens 50a of the camera 50. The camera 50 captures images of the surroundings of the vehicle.

The ejection nozzle 1c removes an object, such as a rain drop, on the lens 50a of the camera 50 by ejecting, from the jet orifice, the compressed gas sent out from the gas ejection apparatus 1a via the hose 1b. Thus, the gas ejection system 1 aids a field of view of a driver of the vehicle, and secures accurate sensing of an approaching object.

In a case where the ejection nozzle 1c is installed outside, if there is a rain drop around the gas jet orifice of the ejection nozzle 1c, the ejection nozzle 1c may draw up the rain drop to an inside of the ejection nozzle 1c from the jet orifice due to capillarity action. While the drawn rain drop is in the inside of the ejection nozzle 1c, if the gas ejection apparatus 1a ejects gas to the lens 50a of the camera 50, the gas ejection apparatus 1a causes water drops to be on the lens 50a of the camera 50.

Thus, a surface around the jet orifice and a gas flow surface inside the ejection nozzle 1c are water-repellent. Thus, even if there is a water drop around the jet orifice, it is possible to prevent the water drop from entering the inside of the ejection nozzle 1c from the jet orifice.

The gas compressor 10 is a rotary gas compression mechanism. More specifically, the gas compressor 10 includes a cylinder 11 and a rotating body 12, as shown in FIG. 1B. The cylinder 11 includes cylinder walls 11a, sending outlets 11b, flow paths 11c, and gas inlets 11d. In a case where the gas ejection system 1 is installed on a vehicle, the gas ejection system 1 needs to be compact, lightweight and low cost. Therefore, it is recommended that the cylinder 11 and the rotating body 12 should be made from a resin and the like.

The cylinder 11 is formed in a cylindrical shape, for example, and has a cylinder chamber CC inside. The cylinder walls 11a are, for example, flat-plate shaped, and are provided so as to be point symmetric with respect to a rotation axis axR to divide the cylinder chamber CC substantially along a diameter of the cylinder chamber CC that is in a cylindrical shape. Thus, the cylinder chamber CC is divided into two sections (hereinafter, referred also to as “divided cylinder chambers CC) by the cylinder walls 11a.

The sending outlets 11b are provided to the two divided cylinder chambers CC on a side of a circumference of the cylinder 11 (i.e., an end wall of the cylinder 11 adjacent to the circumference of the cylinder 11). It is recommended that the sending outlets 11b should be provided in close contact with the circumference of a circular end face of the cylinder 11. However, if the sending outlets 11b are provided near the circumference of the end face of the cylinder 11, the sending outlets 11b may not necessarily be in close contact with the circumference of the cylinder 11. The sending outlets 11b are examples of vents. The sending outlets 11b are apertures provided to a ceiling of the cylinder chamber CC near the two cylinder walls 11a in a point symmetric position with respect to the rotation axis axR, such that each of the two divided cylinder chambers CC is connected to an outside of the cylinder 11 via each of the sending outlets 11b. The compressed gas generated by a rotary motion of the rotating body 12, described later, is ejected, via the sending outlets 11b, from each of the two divided cylinder chambers CC.

The flow paths 11c are connected to the sending outlets 11b. The flow paths 11c are formed in a point-symmetric shape with respect to the rotation axis axR. Moreover, the flow paths 11c are connected to the forwarder 1d above the rotation axis axR. In other words, each of the flow paths 11c interconnects the sending outlet 11b of each of the plurality of the divided cylinder chambers CC with the output tube 1d located at an axial center of the cylinder 11. The compressed gas sent from the divided cylinder chambers CC via the sending outlets 11b is led to the forwarder 1d through the flow paths 11c (see an arrow 101 in FIG. 1B), and then is ejected to the lens 50a of the camera 50 from the jet orifice of the ejection nozzle 1c through the hose 1b.

The gas inlets 11d are apertures provided on an outer wall of the cylinder 11 and below the sending outlets 11b to connect the cylinder chamber CC with the outside of the cylinder 11. Gas taken in or introduced by the rotary motion of the rotating body 12, described later, is led to the cylinder chamber CC via the gas inlets 11d.

The rotating body 12 includes blades 12a, a rotation base 12b, and a shaft 12c. The rotation base 12b is formed in a circular flat plate shape, and is rotatably provided around the rotation axis axR (see an arrow 102 in FIG. 1B).

More concretely, the rotation base 12b includes a driven gear 12d on a surface of the rotation base 12b that is opposite to a surface on which the cylinder 11 is provided. The driven gear 12d receives a driving force of a motor, for example, by being engaged with a drive gear that is connected to the motor so that the rotation base 12b rotates about the rotation axis axR in a predetermined direction.

Moreover, in a free state in which the rotation base 12b is free from the driving force of the motor, the rotation base 12b is biased by a spring in a direction opposite to the predetermined direction of rotation caused by the motor. The blades 12a further divide the divided cylinder chambers CC inside the cylinder 11 into a plurality of sections by the rotary motion of the blades 12a to compress the gas in the divided cylinder chambers CC and then to send out the compressed gas to the outside of the divided cylinder chambers CC. Each of the blades 12a is formed in a flat plate shape, and is provided so as to stand to separate the rotation base 12b along a diameter thereof on the surface opposite to the surface on which the driven gear 12d is provided. Moreover, each blade 12a has a gas intake valve 14 on a wall.

The shaft 12c is a shaft for rotation about the rotation axis axR. The shaft 12c is provided between the two blades 12a and connects the two blades 12a. The rotation base 12b of the rotating body 12, configured as described above, is rotatably engaged with the cylinder 11, and rotates inside the cylinder chamber CC. Thus, a cycle of steps including intake and ejection of gas is performed, and the compressed gas is generated.

More specifically, as shown in FIG. 1C, in a state “before intake of gas,” the rotating body 12 of the gas compressor 10 is free from the driving force of the motor, as described above, and the blades 12a are pushed onto the cylinder walls 11a because the blades 12a are biased by “spring tension” of the springs.

Then, when each of the blades 12a rotates by the “driving force of the motor” in a direction in which the blades 12a move away from the cylinder wall 11a, a space SP between the blade 12a and the cylinder wall 11a is expanded, and a negative pressure is generated in the space SP, and then the gas is “taken in.”

Once the blade 12a reaches a predetermined position, the driving force of the motor is released. The blade 12a becomes free from the driving force of the motor, and swiftly moves back to the state in which the blades 12a abut on the cylinder walls 11a due to the “spring tension” of the springs. At that time, the space SP is compressed, i.e., the compressed gas is generated from the gas “taken in” the space SP, and the compressed gas is “ejected” from the sending outlets 11b at a high pressure.

A more detailed configuration of the gas ejection apparatus 1a of this embodiment including the rotation mechanism will be described below with reference to FIG. 2A and the subsequent drawings. FIG. 2A is a perspective view illustrating an internal configuration of the gas ejection apparatus 1a.

As described above, as shown in FIG. 2A, the gas ejection apparatus 1a includes the gas compressor 10, and the gas compressor 10 includes the cylinder 11 and the rotating body 12. The rotating body 12 includes the driven gear 12d. The driven gear 12d is provided coaxially with the rotation axis axR. As described above, the gas compressor 10 works by the rotational mechanism so that a configuration of the gas compressor 10 can be space-saving and more compact as compared to a piston type.

Moreover, the rotating body 12 includes biasing springs 12e corresponding to the “springs” mentioned above. The biasing springs 12e are provided to bias the rotating body 12 in the direction opposite to the predetermined direction in which the rotating body 12 is rotated by the motor. Moreover, the gas compressor 10 further includes a drive part 13. The drive part 13 includes a motor 13a, a first gear 13b, a second gear 13c, a third gear 13d, and a preceding gear 13e.

The motor 13a is one of a rotary drive source, for example, an electric motor. The motor 13a may be a hydraulic motor or the like. The motor 13a of this embodiment rotates in one direction, in principle. Moreover, for example, a worm, not illustrated, is formed on an output shaft of the motor 13a, and the output shaft of the motor 13a meshes with the first gear 13b via the worm.

The first gear 13b meshes with the second gear 13c. The second gear 13c meshes with the third gear 13d. The preceding gear 13e is provided coaxially with the third gear 13d so as to engage with the driven gear 12d of the rotating body 12.

The rotational driving force of the motor 13a is transmitted to the preceding gear 13e via the first gear 13b, the second gear 13c, and the third gear 13d meshing with one another, as described above. A number of the gears and mesh with those gears from the motor 13a to the preceding gear 13e are not limited to an example shown in the figures.

Next, FIG. 2B is a schematic diagram illustrating a configuration of the driven gear 12d and the preceding gear 13e viewed from above. FIG. 2B is the schematic diagram illustrating only the driven gear 12d and the preceding gear 13e viewed from a Z-axis positive direction.

As shown in FIG. 2B, the driven gear 12d is a partially-toothless gear, i.e., a gear of which some of continuous teeth are cut out. The driven gear 12d includes at least a first tooth 12da, a second tooth 12db, a last tooth 12dc, and a toothless portion 12dd.

The first tooth 12da is a tooth that is first engaged with the preceding gear 13e in one cycle of intake and ejection of gas, and the last tooth 12dc is a tooth that is last engaged with the preceding gear 13e. In the description below, when being viewed from the Z-axis positive direction, the driven gear 12d rotates counterclockwise about the rotation axis axR by the rotational driving force of the motor 13a transmitted from the preceding gear 13e. Accordingly, the biasing springs 12e bias the driven gears 12d to cause the driven gears 12d to rotate clockwise.

The preceding gear 13e is also formed as a partially-toothless gear, i.e., a gear of which some of continuous teeth are cut out. The preceding gear 13e includes, at least a first tooth 13ea, a last tooth 13eb, and a toothless portion 13ec.

The first tooth 13ea is a teeth that is first engaged with the driven gear 12d in the one cycle of intake and ejection of gas, and the last tooth 13eb is a teeth that is last engaged with the driven gear 12d. In the description below, when being viewed from the Z-axis positive direction, the preceding gear 13e rotates clockwise about the rotation axis axR by the rotational driving force of the motor 13a.

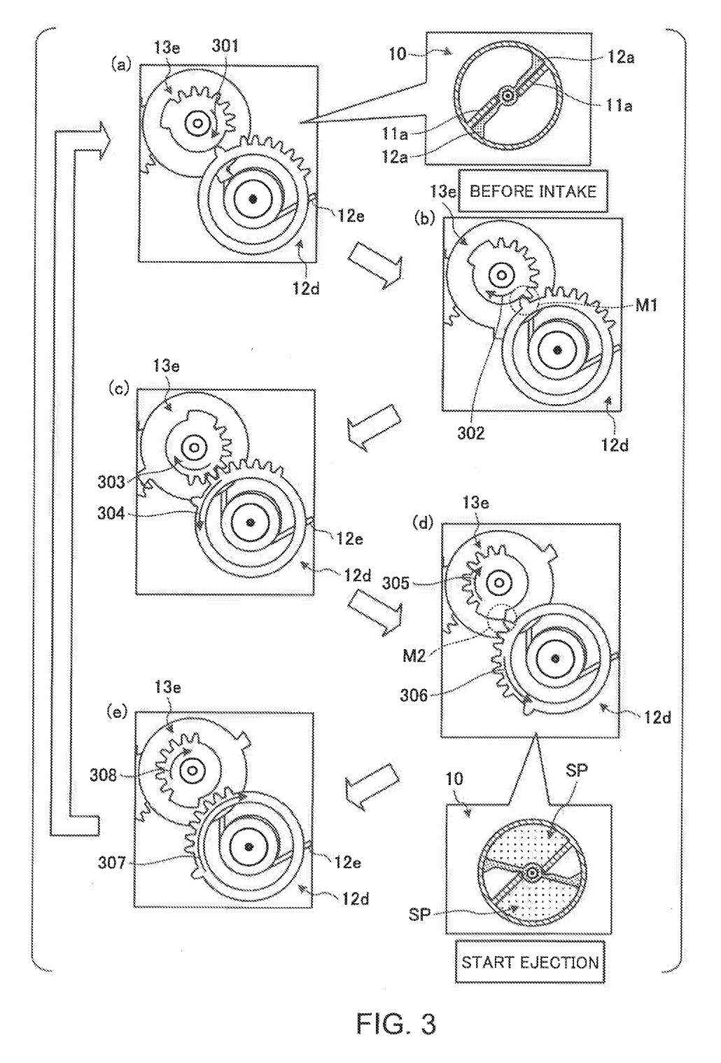

Next, a motion of the gas compressor 10 by engagement of the driven gear 12d with the preceding gear 13e will be described in more detail, with reference to FIG. 3. FIG. 3 illustrates the motion of the gas compressor 10 in more detail.

Since the driven gear 12d and the preceding gear 13e are formed as the partially-toothless gear, as described above, there is a state in which the driven gear 12d and the preceding gear 13e are not engaged with each other due to the toothless portions. The gas ejection system 1 of this embodiment makes use of the state in which the driven gear 12d and the preceding gear 13e are not engaged with each other.

As shown in FIG. 3(a), although the motor 13a is activated and the preceding gear 13e rotates in a direction shown by an arrow 301 in FIG. 3(a), the preceding gear 13e is not engaged with the driven gear 12d yet. Such a state, as shown in FIG. 3, is the state “before intake of gas” by the gas compressor 10.

In the state “before intake of gas,” the blades 12a of the gas compressor 10 are pushed onto the cylinder walls 11a by the “spring tension” of the biasing spring 12e.

Then, when the preceding gear 13e rotates further in a same direction, as shown in FIG. 3 (b), from such a state (see an arrow 302 in FIG. 3 (b)), the driven gear 12d and the preceding gear 13e start to engage with each other (see a portion M1 in FIG. 3 (b)). This is a state in which the gas compressor 10 starts to take gas in.

Then, as shown in FIG. 3 (c), further rotation of the preceding gear 13e in the same direction (see an arrow 303 in FIG. 3 (c)) causes the engaged driven gear 12d to rotate counterclockwise (see an arrow 304 in FIG. (c)) against a biasing power of the biasing spring 12e. In such a state, the gas compressor 10 is taking the gas in.

In other words, when the driven gear 12d is engaged with the preceding gear 13e, the driven gear 12d is caused to rotate counterclockwise because a power to rotate the driven gear 12d in the predetermined direction (counterclockwise) caused by the motion of the motor 13a connected to the preceding gear 13e is greater than a power to rotate the driven gear 12d in an opposite direction (clockwise) caused by the biasing power of the biasing spring 12e.

In other words, the power to rotate the driven gear 12d in the direction opposite (clockwise) to the predetermined direction caused by the biasing power of the biasing spring 12e is smaller than the power to rotate the driven gear 12d in the predetermined direction (counterclockwise) caused by the motion of the motor 13a.

However, when the driven gear 12d is not engaged with the preceding gear 13e, i.e., when the driven gear 12d gets disengaged with the preceding gear 13e due to the toothless portion so that the driven gear 12d falls into the free state, the driven gear 12d rotates in the opposite direction (clockwise) because only the biasing power of the biasing spring 12e acts on the driven gear 12d.

In other words, the biasing power of the biasing spring 12e to rotate the driven gear 12d in the opposite direction (clockwise) is smaller than the power of the motor 13a to rotate the driven gear 12d in the predetermined direction (counterclockwise).

More specifically, as shown in FIG. 3 (d), due to further rotations (see arrows 305 and 306 in FIG. 3 (d)) of the preceding gear 13e and the driven gear 12d from a state shown in FIG. 3 (c), a time point comes at which the driven gear 12d gets disengaged from the preceding gear 13e (see a M2 portion in FIG. 3 (d)). As shown in FIG. 3, the time point is “start of gas ejection” of the gas compressor 10.

Then, as shown in FIG. 3 (e), when being disengaged from the preceding gear 13e, the driven gear 12d springs back clockwise due to the spring tension of the biasing spring 12e (see an arrow 307 in FIG. 3 (e)), and the taken gas is ejected to the space SP while being compressed. Moreover, the preceding gear 13e rotates in the same direction (see an arrow 308 in FIG. 3 (e)), and the cycle starting from (a) shown in FIG. 3 is repeated for a next one cycle of intake and ejection of gas.

As described above, the time point at which the preceding gear 13e gets disengaged from the driven gear 12d is caused by the toothless portions of the gears 13e and 12d. At the time point, the driven gear 12d springs back clockwise by the biasing spring 12e. Thus, the motor 13a only rotates in one same direction. Therefore, the gas can be compressed in such a simple configuration.

Moreover, in this embodiment, since the gas compressor 10 is provided as the rotary gas compression mechanism, the gas compressor 10 can be compact as compared to, for example, a piston gas compression mechanism in which a piston moves back and forth in a cylinder. In other words, according to this embodiment, the gas can be compressed in the simple and compact configuration.

It is important for the gas ejection apparatus 1a to efficiently send the compressed gas from the cylinder 11. Therefore, the compressed gas can be efficiently sent out from the cylinder 11 due to an improved configuration of the cylinder 11 of this embodiment.

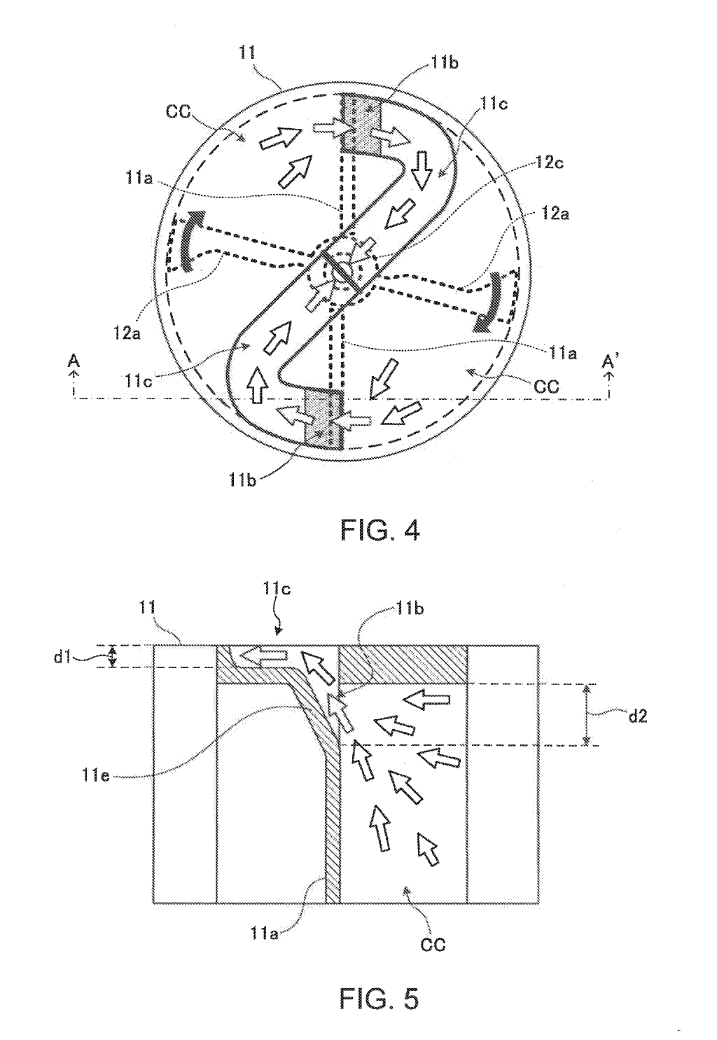

The configuration of the cylinder 11 of this embodiment and a flow of the compressed gas sent out from the cylinder 11 will be described below, with reference to FIGS. 4 and 5. FIG. 4 is a top view illustrating the end face on a side on which the flow paths 11c of the cylinder 11 of this embodiment are provided. FIG. 5 is a cross-sectional view illustrating the cylinder 11 of this embodiment along a line A-A′ shown in FIG. 4.

The cylinder walls 11a provided inside the cylinder 11 and the blades 12a during intake of gas are shown by dotted lines, and a rotary direction of the blades 12a when the gas is compressed and sent out is shown by black bold arrows in FIG. 4. Moreover, a flowing direction of the compressed gas is shown by white arrows in FIGS. 4 and 5.

As described above, as shown in FIG. 4, the cylinder 11 is formed in the cylindrical shape, and includes the plurality of (two in this embodiment) cylinder chambers CC divided substantially along the diameter of the cylinder 11 by the cylinder walls 11a. The blades 12a take the gas into the divided cylinder chambers CC, and compress the taken gas, and then send the compressed gas to the outside, by rotating back and forth about a cylinder axis of the cylinder 11, serving as a rotation axis.

As described above, the blades 12a rotate back and forth. Thus, a motion range of the blades 12a is greater on a side closer to the circumference of the cylinder 11, as compared to a center side closer to the cylinder axis. Accordingly, the blades 12a compress the gas with a greater force on the side closer to the circumference of the cylinder 11, as compared to the side closer to the cylinder axis of the cylinder 11.

Therefore, in this embodiment, the sending outlets 11b are provided to the divided cylinder chambers CC on the side closer to the circumference of the end face of the cylinder 11. Thus, the gas ejection apparatus 1a more efficiently sends out the compressed gas from the sending outlets 11b, as compared to a case in which sending outlets are provided on the center side of the end face.

Moreover, as shown in FIG. 5, each of the sending outlets 11b includes a sloped wall 11e that slopes upward from an inside of the cylinder 11 toward the outside of the cylinder 11 the sloped wall 11e slopes at a positive angle with respect to an axial direction of the cylinder 11. Thus, the gas sent out from the divided cylinder chambers CC to the sending outlets 11b is led to the flow paths 11c through smooth channels along the sloped wall 11e.

Thus, the gas ejection apparatus 1a prevents a flow speed of the compressed gas from decreasing, as compared to, for example, a case in which sending outlets that straightly penetrate a front side and a back side of the end face of the cylinder 11 are provided. More specifically, in the case where the sending outlet penetrating the front and back sides of the end face of the cylinder 11 is provided, the flowing direction of the gas toward the sending outlets is changed by 90 degrees from the rotary direction of the blades 12a because the gas is sent out to the sending outlets by the rotary motion of the blades 12a. Thus, the flow speed of the gas decreases.

On the other hand, in the case of the gas sent out to the sending outlets 11b by the rotary motion of the blades 12a in the gas ejection apparatus 1a, as shown in FIG. 5, an angle at which the flowing direction of the gas needs to be changed is obtuse and greater than 90 degrees. Thus, it is possible to prevent the flow speed from decreasing.

Moreover, as shown in FIG. 4, the cylinder 11 includes the flow paths 11c to gather the gas into the axial center of the end face of the cylinder 11 (i.e., a center of the end face) from the sloped wall 11e of the sending outlets 11b. Atop surface of each of the flow paths 11c is tightly shielded by a cover, and the flow paths 11c are connected to the forwarder 1d in the axial center of the cylinder 11. Thus, the gas ejection apparatus 1a efficiently sends out the compressed gas by merging the compressed gas sent out from each of the sending outlets 11b.

Moreover, each of the flow paths 11c is formed in a curved shape, running to the axial center of the cylinder 11. Thus, the gas ejection apparatus 1a prevents the flow speed of the compressed gas from decreasing, as compared to, for example, a case in which a straight flow path is provided to the end face of the cylinder 11.

More specifically, in the case where the straight flow path is provided to the end face of the cylinder 11, the flowing direction of the gas sent out to the sending outlets is changed at a sharp angle, and the gas sent to the sending outlets is led to the axial center of the cylinder 11. Thus, the flow speed of the gas is decreased.

On the other hand, the flow paths 11c of the gas ejection apparatus 1a are curved such that the gas is led to the axial center of the cylinder 11 through the gently curved path. Thus, the flow speed of the compressed gas can be prevented from decreasing.

Moreover, as shown in FIG. 4, a width of each flow path 11c is the same as a width of each sending outlet 11b. However, as shown in FIG. 5, a depth d1 of the flow path 11c is smaller than a vertical length d2 (length in a direction parallel to the cylinder axis of the cylinder 11) of the sending outlet 11b.

In other words, a cross-section of the flow path 11c has an area smaller than an opening area of the sending outlet 11b. Thus, in the gas ejection apparatus 1a, a path from the cylinder chamber CC to the flow path 11c via the sending outlet 11b is gradually narrowed.

Thus, it is possible to efficiently send out the compressed gas in the gas ejection apparatus 1a because the flow speed of the compressed gas can be greater until the gas reaches the axial center of the cylinder 11 via the sending outlet 11b and the flow path 11c from the cylinder chamber CC.

Moreover, as shown in FIG. 4, shapes of the divided cylinder chambers CC are all the same, and shapes of the blades 12a provided inside the divided cylinder chambers CC are all the same. The blades 12a rotate at a same rotary speed in a same direction (e.g. clockwise) about the cylinder axis of the cylinder 11. Thus, since the gas ejection apparatus 1a efficiently sends out the compressed gas by outputting a same amount of the compressed gas at the same flow speed from the sending outlets 11b, respectively.

Moreover, the gas ejection apparatus 1a generates the compressed gas by simultaneously rotating, in the same direction, the two blades 12a provided point-symmetrically with respect to the rotation axis. Thus, it is possible to improve quietness, as compared to a case in which a same amount of compressed gas is generated by one blade.

More concretely, in a case where the same amount of gas compressed by the gas ejection apparatus 1a is generated by one blade, a blade bigger than the blades 12a of the gas ejection apparatus 1a is necessary. Accordingly, a greater impact sound is generated when the blade hits the cylinder wall.

On the other hand, since the gas ejection apparatus 1a generates the compressed gas by rotating the blades 12a that are relatively small, the impact sound generated when the blades 12a hit the cylinder walls 11a is small. Thus, it is possible to improve the quietness.

Moreover, in a case where one blade rotates back and forth about a rotation axis, an off-center load is added to the rotation axis. Thus, durability and stability in gas compression are decreased. On the other hand, in the gas ejection apparatus 1a, a balanced load is added to the rotation axis by the two blades 12a. Thus, the durability of the gas ejection apparatus 1a is improved, and the gas ejection apparatus 1a compresses gas stably. Therefore, it is possible to send out the compressed gas efficiently.

The foregoing embodiment describes the case in which the two divided cylinder chambers CC and the two blades 12a are provided inside the cylinder 11. However, the gas ejection apparatus 1a may include three or more cylinder chambers CC and three or more blades inside the cylinder.

In such a configuration, a plurality of cylinder chambers are formed in a same shape so as to be provided point-symmetrically with respect to the rotation axis of the blades. Moreover, a plurality of the blades are also formed in a same shape so as to be point symmetric with respect to the rotation axis of the blades.

Thus, in the gas ejection apparatus 1a, a load added to the rotation axis from the plurality of blades can be balanced. Therefore, the durability and the stability in gas compression can be improved so that the compressed gas can be sent out more efficiently.

While the invention has been shown and described in detail, the foregoing description is in all aspects illustrative and not restrictive. It is therefore understood that numerous other modifications and variations can be devised without departing from the scope of the invention.

What is claimed is:

1. A gas ejection apparatus comprising:
a cylindrical cylinder;
cylinder walls that divide an inside of the cylinder into a plurality of chambers;
blades that send out gas in the plurality of chambers to an outside of the cylinder by a rotary motion of the blades that compresses the gas; and
a gas sending outlet that is provided to each of the plurality of chambers on an end wall of the cylinder adjacent to a circumference of the cylinder.

2. The gas ejection apparatus according to claim 1, wherein
the gas sending outlet includes a sloped wall that slopes upward from the inside of the cylinder toward the outside of the cylinder, the sloped wall sloping at a positive angle with respect to an axial direction of the cylinder.

3. The gas ejection apparatus according to claim 2, further comprising
a gas flow path along the end wall of the cylinder, the gas flow path interconnecting the gas sending outlet of each of the plurality of chambers with a gas exit located at an axial center of the cylinder.

4. The gas ejection apparatus according to claim 1, wherein
the plurality of chambers are adjacent to each other in a circumferential direction of the cylinder.

5. The gas ejection apparatus according to claim 1, wherein
the blades are rotated about a central axis of the cylinder in a back-and-forth rotary motion that alternately (i) introduces the gas into the plurality of chambers and (ii) compresses the gas before sending the gas to the outside of the cylinder through the gas sending outlet of each of the plurality of chambers.

6. The gas ejection apparatus according to claim 5, further comprising
a biasing member that biases the blades in a first rotary direction; and
a motor that intermittently applies a driving force in a second rotary direction that is opposite to the first rotary direction to cause the blades to be rotated with the back-and-forth rotary motion.

7. The gas ejection apparatus according to claim 6, wherein
the biasing member is a spring.
